(19) United States
(12) Patent Application Publication
(10) Pub. No.: US 2026/0110552 A1
(43) Pub. Date: Apr. 23, 2026

(54) CROP SENSORS AND RELATED DEVICES, SYSTEMS, AND METHODS

(71) Applicant: Ag Leader Technology, Ames, IA (US)

(72) Inventor: Brett Johnson, Ames, IA (US)

(21) Appl. No.: 19/366,202

(22) Filed: Oct. 22, 2025

Related U.S. Application Data
(60) Provisional application No. 63/710,492, filed on Oct. 22, 2024.

(51) Int. Cl. G01D 5/14; A01D 41/127

(52) U.S. Cl. CPC G01D 5/14; A01D 41/127

(57) ABSTRACT

An agricultural stalk sensor, having at least a first wand comprising a first rib extending longitudinally along a first side of the first wand. The stalk sensor optionally having a second wand comprising a second rib extending longitudinally along a first side of the second wand. A stalk sensor system wherein the first rib and the second rib at least partially overlap when the first wand and the second wand are in a resting position.

### CROSS-REFERENCE TO RELATED APPLICATION(S)

This application claims the benefit under 35 U.S.C. § 119(e) to U.S. Provisional Application 63/710,492, filed Oct. 22, 2024, and entitled “Crop Sensors and Related Devices, Systems, and Methods,” which is hereby incorporated herein by reference in its entirety for all purposes.

### TECHNICAL FIELD

The disclosure relates to agricultural sensors and implements, including stalk sensors for use on harvesters and other agricultural implements.

### BACKGROUND

Various sensors for measuring and counting stalks and collecting certain data relating to harvest and planting are known in the art. Various sensors are disclosed in U.S. application Ser. Nos. 16/445,161, 16/800,469, 17/013,037, 17/226,002, and 18/516,514, each of which has been incorporated by reference herein.

### BRIEF SUMMARY

Disclosed herein are various crop sensors for agricultural implements, including for use on row crop harvesters. These sensors, including an overlap feature, are configured to increase signal accuracy by increasing distance of wand deflection as stalks pass through the sensor during harvest operations.

In Example 1, an agricultural stalk sensor, comprising a first wand comprising a first rib extending longitudinally along a first side of the first wand; a second wand comprising a second rib extending longitudinally along a first side of the second wand, wherein the first rib and the second rib at least partially overlap when the first wand and the second wand are in a resting position.

Example 2 relates to the agricultural stalk sensor of Example 1, wherein the first rib and the second rib increase in height along a length of each respective wand.

Example 3 relates to the agricultural stalk sensor of Examples 1 and 2, wherein distal ends of the first wand and the second wand do not overlap.

Example 4 relates to the agricultural stalk sensor of Examples 1-3, wherein the first rib and the second rib each have a maximum height of about 1/8 inch.

Example 5 relates to the agricultural stalk sensor of Examples 1-4, wherein the first rib and the second rib are integral to their respective wands.

Example 6 relates to the agricultural stalk sensor of Examples 1-5, wherein the first rib and the second rib are affixed to their respective wands by an adhesive or fastener.

Example 7 relates to the agricultural stalk sensor of Examples 1-6, wherein the first rib and the second rib are configured to increase stalk sensor signals during harvest.

Example 8 relates to the agricultural stalk sensor of Examples 1-7, wherein the first rib and second rib are wear strips.

In Example 9, an agricultural stalk sensor, comprising: a first wand comprising a first rib extending longitudinally along a first side of the first wand.

Example 10 relates to the agricultural stalk sensor of Example 9, wherein the first rib increases in height along a length of the first wand.

Example 11 relates to the agricultural stalk sensor of Examples 9-10, wherein the first rib has a maximum height of ⅛ inch.

Example 12 relates to the agricultural stalk sensor of Examples 9-11, further comprising a second wand comprising a second rib extending longitudinally along a first side of the second wand, wherein the first rib and the second rib at least partially overlap when the first wand and the second wand are in a resting position.

Example 13 relates to the agricultural stalk sensor of Examples 9-12, wherein the second rib increases in height along a length of the second wand.

Example 14 relates to the agricultural stalk sensor of Examples 9-13, wherein the second rib has a maximum height of ⅛ inch.

Example 15 relates to the agricultural stalk sensor of Examples 9-14, wherein distal ends of the first wand and the second wand do not overlap.

Example 16 relates to the agricultural stalk sensor of Examples 9-15, wherein the first rib and second rib are wear strips.

Example 17 relates to the agricultural stalk sensor of Examples 9-16, wherein the first rib and the second rib are affixed to their respective wands by an adhesive or fastener.

Example 18 relates to the agricultural stalk sensor of Examples 9-17, wherein the first rib and the second rib are configured to increase stalk sensor signals during harvest.

In Example 19, an agricultural stalk sensor wand comprising a body having a side and a rib extending along the side of the body and increasing in height along the side of the body.

Example 20 relates to the agricultural stalk sensor of Example 19, wherein the rib is configured to increase sensor signals from passing stalks during harvest.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a perspective view of a dual wand system on a harvester, according to one implementation.

FIG. 2 is a perspective view of a wand having an overlap feature, according to one implementation.

FIG. 3 is a top view of distal ends of a dual wand system, each wand having an overlap feature, according to one implementation.

FIG. 4 is a perspective view of a dual wand system, each wand having an overlap feature, according to one implementation.

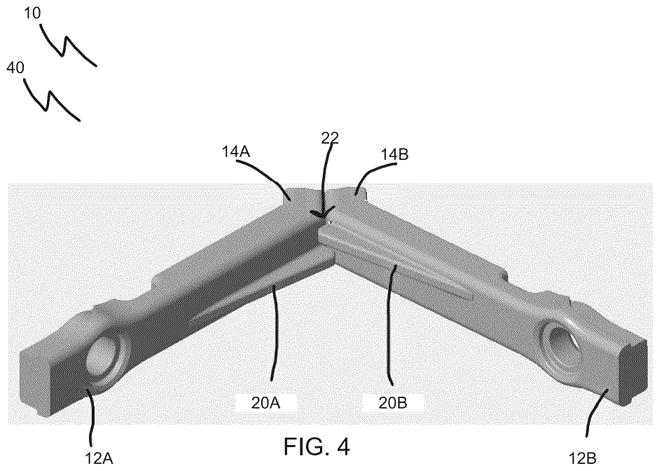

### DETAILED DESCRIPTION

Disclosed herein is a crop sensor having at least one wand, and optionally two wands. The wand(s) may include an extension, protrusion, or rib (referred to generally herein as an “overlap feature”). The overlap feature may be configured to increase the amount of deflection of the wands when stalks travel into the harvesting head and contact the wand(s). In various further implementations, the overlap feature may also act as a wear strip, that may help define or indicate when the wand(s) should be replaced as a result of wear.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sept. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sept. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices, and Methods,” U.S. patent application Ser. No. 19/305,530, filed Aug. 20, 2025, entitled “Crop Sensor Wands and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,”each of which is incorporated herein by reference.

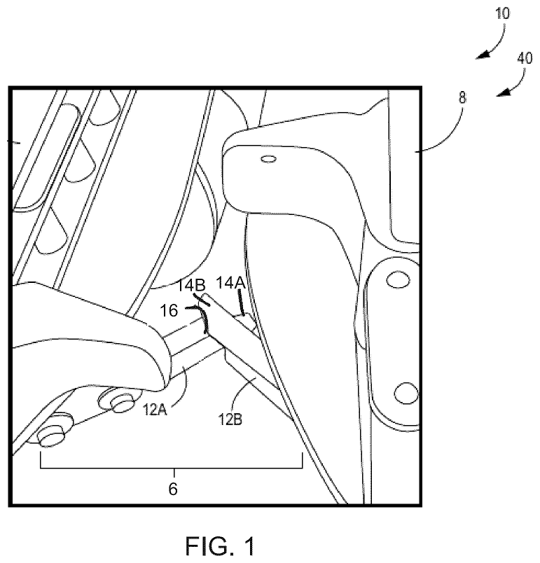

Certain prior known sensors 10, such as that shown in FIG. 1, include wands 12A, 12B configured with overlapping tips 14A, 14B. As can be seen in these types of systems the tips 14A, 14B of the two wands 12A, 12B overlap completely (shown at 16). This style of wand 12A, 12B may increase contact time with stalks and therefore inhibit the ability of the system 40 to sense closely spaced stalks. That is, the overlapping tips 14A, 14B cause the wands 12A, 12B to be longer than wands 12A, 12B that do not have overlapping tips 14A, 14B; and because stalks must travel the length of the wands 12A, 12B longer wands 12A, 12B have an increased contact time with stalks passing through the sensor 10. With an increased contact time, the wands 12A, 12B may not be able to fully rebound before the next stalk is encountered causing errors in the system 40 such that individual stalks may not be accurately sensed and / or counted as would be generally understood by those of skill in the art.

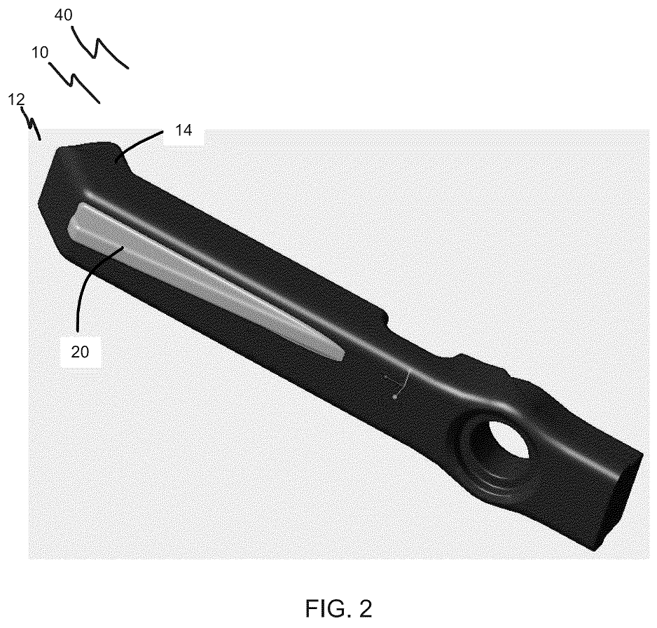

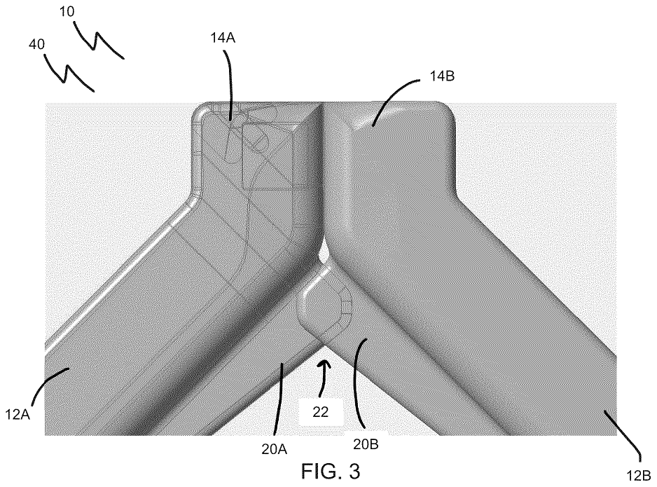

Turning now to FIG. 2, the disclosed overlap feature 20 is shown on a wand 12. In these and other implementations, the feature 20 may generally be a ramp or incline style protrusion or rib (that is increasing in height along the length of the wand 12). In various implementations the overlap feature 20 is an extension, protrusion, rib extending along a length of a wand or wands such that in implementations having a pair of wands 12A, 12B and the wands 12A, 12B are in the neutral/resting position at least a portion of the overlap feature 20 of one wand 12A overlaps (shown at 22) with the overlap feature 20 of the second wand 12B, shown for example in FIG. 3. As shown in FIG. 3, the distal end of the overlap features 20A, 20B of the wands 12A, 12B overlap in part.

In some implementations, the overlap features 20A, 20B may be offset from the centerline of their respective wands 12A, 12B in a manner that renders the first wand 12A and second wand 12B, including the overlap features 20A, 20B, to be identical parts for manufacturing purposes. In such implementations, the wands 12A, 12B may be manufactured interchangeably, and may take their designation as a first wand 12A or second wand 12B upon installation relative to one another. For the purposes of this disclosure, the wands 12A, 12B that may be manufactured interchangeably may be referred to as “self-engaging.” These implementations may allow for wands 12A, 12B to have overlapping ribs or the like, while only requiring a single part to be designed and manufactured.

In various implementations, the feature 20 may be molded with/integral to the wand 12. In other implementations, the feature 20 may be affixed to the wand 12 via a fastener or adhesive. The feature 20 may optionally be removable/replaceable.

In various implementations, the maximum height of the feature 20 may be about ⅛″. In implementations where the sensor 10 includes two wands 12 and a feature 20 height of ⅛″, the resulting space between the wands 12A, 12B when fully open would be ¼″ greater than a similar sensor 10 set up that does not include the overlap feature 20. The overlap feature can be made taller or shorter, as desired. Various alternative dimensions of the feature 20 are possible and would be understood by those of skill in the art.

As would be understood in light of this disclosure, the overlap feature 20 increases the sensor signal when stalks go down the center of the pair of wands 12A, 12B so that the system 40 can better count small stalks. The disclosed overlap feature 20 does not greatly increase the contact time with stalks, such that the overlap feature does not compromise the ability to count doubles.

Another benefit of a sensor 10 including the feature 20 is that if a stalk is off center entering the pair of wands then only one wand will deflect by half of the total opening distance, therefore more balancing of the signal peaks from centered to off center occurs. That is, in the case of an off-center stalk entering the sensor 10 there will be a signal with a higher peak than before the addition of the overlapping feature. By deflecting the wands ¼″ more when the stalk goes down the center, the system 40 can make a ¼″ stalk look like a ½″ stalk signal-wise, and a ½″ stalk look like a ¾″ stalk, and so on. Because it is small stalks that cause a small signal, by increasing the deflection, the magnetic response on the magnetometer (which is non-linear) is increased thereby increasing the ability of the system 40 to detect these smaller stalks.

As would be understood, stalks going down the middle will deflect both the right and the left wand to the total of the overlap, whereas if the stalk only deflects one wand then only that wand's ramp will add to the deflection. This is helpful to not increase the signal peak on one wand where the signal peak is already sufficiently defined.

An additional benefit of the ramp 20 (overlap feature 20) is that the ramp can act as a wear strip to define when it is time to replace the wands from wear. That is, upon repeated encounter with stalks the friction of the stalks passing along the overlap feature 20 will cause the material to wear. After a period, the material may be worn down to such a degree as to indicate to an operator that the overlap feature 20 and/or entire wand 12 may need to be replaced. For example, the material of the ramp 20 may change color upon wear to a depth that requires replacement. Various alternative indicators are possible and would be understood.

Although the disclosure has been described with references to various embodiments, persons skilled in the art will recognize that changes may be made in form and detail without departing from the spirit and scope of this disclosure.

What is claimed is:

1. An agricultural stalk sensor, comprising:
(a) a first wand comprising a first rib extending longitudinally along a first side of the first wand;
(b) a second wand comprising a second rib extending longitudinally along a first side of the second wand;
wherein the first rib and the second rib at least partially overlap when the first wand and the second wand are in a resting position.

2. The stalk sensor of claim 1, wherein the first rib and the second rib increase in height along a length of each respective wand.

3. The stalk sensor of claim 1, wherein distal ends of the first wand and the second wand do not overlap.

4. The stalk sensor of claim 1, wherein the first rib and the second rib each have a maximum height of about ⅛ inch.

5. The stalk sensor of claim 1, wherein the first rib and the second rib are integral to their respective wands.

6. The stalk sensor of claim 1, wherein the first rib and the second rib are affixed to their respective wands by an adhesive or fastener.

7. The stalk sensor of claim 1, wherein the first rib and the second rib are configured to increase stalk sensor signals during harvest.

8. The stalk sensor of claim 1, wherein the first rib and second rib are wear strips.

9. An agricultural stalk sensor, comprising: a first wand comprising a first rib extending longitudinally along a first side of the first wand.

10. The agricultural stalk sensor of claim 9, wherein the first rib increases in height along a length of the first wand.

11. The agricultural stalk sensor of claim 10, wherein the first rib has a maximum height of ⅛ inch.

12. The agricultural stalk sensor of claim 9, further comprising a second wand comprising a second rib extending longitudinally along a first side of the second wand, wherein the first rib and the second rib at least partially overlap when the first wand and the second wand are in a resting position.

13. The agricultural stalk sensor of claim 12, wherein the second rib increases in height along a length of the second wand.

14. The agricultural stalk sensor of claim 13, wherein the second rib has a maximum height of 1/8 inch.

15. The agricultural stalk sensor of claim 12, wherein distal ends of the first wand and the second wand do not overlap.

16. The agricultural stalk sensor of claim 12, wherein the first rib and second rib are wear strips.

17. The agricultural stalk sensor of claim 12, wherein the first rib and the second rib are affixed to their respective wands by an adhesive or fastener.

18. The agricultural stalk sensor of claim 12, wherein the first rib and the second rib are configured to increase stalk sensor signals during harvest.

19. An agricultural stalk sensor wand comprising a body having a side and a rib extending along the side of the body and increasing in height along the side of the body.

20. The agricultural stalk sensor wand of claim 19, wherein the rib is configured to increase sensor signals from passing stalks during harvest.
